(19) United States
(12) Patent Application Publication
(10) Pub. No.: US 2011/0134280 A1
(43) Pub. Date: Jun. 9, 2011

(54) SYSTEM AND METHOD FOR CONSTRUCTING HIGH DYNAMIC RANGE IMAGES

(75) Inventors: Sen Yih CHOU, Hsinchu City (TW); Chieh Yu Wu, Tanzi Township (TW); Yi Chang Chen, Miaoli City (TW)

(73) Assignee: INDUSTRIAL TECHNOLOGY RESEARCH INSTITUTE, Chutung (TW)

(21) Appl. No.: 12/685,775

(22) Filed: Jan. 12, 2010

(30) Foreign Application Priority Data
Dec. 3, 2009 (TW) 098141290

(51) Int. Cl. H04N 9/68; H04N 5/232

(52) U.S. Cl. 348/234; 348/345; 348/E05.045; 348/E09.053

(57) ABSTRACT

A system for constructing a high dynamic range image includes a light generating device, a reflective mirror device, a controller, an image capturing device and an image processing module. The light generating device generates a light beam. The reflective mirror device directs the light beam to an object. The controller generates an intensity controlling signal for controlling the light generating device to modulate an intensity of the light beam in accordance with illuminating parameters, and to generate a direction controlling signal for controlling a reflection direction of the reflective mirror device. The image capturing device obtains an original image of the object or a modulated image of the object. The image processing module analyzes the original image to generate the illuminating parameters, or to construct a high dynamic range image of the object in accordance with the modulated image and the illuminating parameters.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The disclosure relates generally to a system and method for constructing high dynamic range images.

2. Description of Related Art Including Information Disclosed Under 37 CFR 1.97 and 37 CFR 1.98.

In current optical measurement systems, if the surface material, the surface structure or the surface roughness of an object to be measured is inconsistent, large differences in intensities of reflected or scattered light beams will result. Therefore, there is a need to use a single-point type image capturing device with high dynamic range for resolving the intensities of reflected light beams. However, measuring a large area by a single-point type image capturing device with a mechanical movement device requires precise control. In addition, capturing full-field information of the large area takes a long time.

Further, if a charge-coupled device (CCD) sensor or a complementary metal-oxide-semiconductor (CMOS) sensor is utilized for capturing an image of a large area, measurement errors may occur due to the limited dynamic range of the CCD sensor or the CMOS sensor. Various methods have been disclosed to overcome the problem of the limited dynamic range. U.S. Pat. No. 6,753,876 discloses a method for constructing high dynamic range images. The method adjusts an illuminating light with different intensity levels to capture corresponding images. The image captured with a medium light intensity is set as a standard image. Each pixel in the standard image is examined to identify pixels which are above a saturation region or below a noise floor. For each pixel with a saturation level over the saturation region, the pixel light intensity value is replaced by a value multiplied by a corresponding coefficient, so as to obtain a correct pixel light intensity value. The value is taken from a corresponding pixel in an image acquired with a scaled lower illumination level. In contrast, for each dark pixel which is below the noise floor, the pixel light intensity value is replaced by a value multiplied by a corresponding coefficient, so as to obtain a correct pixel light intensity value. The value is taken from a corresponding pixel in an image acquired with a scaled higher illumination level.

### BRIEF SUMMARY OF THE INVENTION

The present disclosure provides a system and method for constructing high dynamic range images. A system for constructing a high dynamic range image according to an exemplary embodiment of the present disclosure is disclosed. The system comprises a light generating device, a reflective mirror device, a controller, an image capturing device and an image processing module. The light generating device is utilized to generate a light beam. The reflective mirror device is utilized to direct the light beam to an object. The controller is utilized to generate an intensity controlling signal for controlling the light generating device to modulate an intensity of the light beam in accordance with illuminating parameters, and to generate a direction controlling signal for controlling a reflection direction of the reflective mirror device. The image capturing device is utilized to obtain an original image of the object or a modulated image of the object. The image processing module is utilized to analyze the original image to generate the illuminating parameters, or to construct a high dynamic range image of the object in accordance with the modulated image and the illuminating parameters.

A system for constructing a high dynamic range image according to another exemplary embodiment of the present disclosure is disclosed. The system comprises a light generating device, an intensity modulator, a reflective mirror device, a controller, an image capturing device and an image processing module. The light generating device is utilized to generate a light beam. The intensity modulator is utilized to modulate the intensity of the light beam in accordance with an intensity controlling signal. The reflective mirror device is utilized to direct the light beam to an object. The controller is utilized to generate the intensity controlling signal in accordance with illuminating parameters, and to generate a direction controlling signal for controlling a reflection direction of the reflective mirror device. The image capturing device is utilized to obtain an original image of the object or a modulated image of the object. The image processing module is utilized to analyze the original image to generate the illuminating parameters, or to construct a high dynamic range image of the object in accordance with the modulated image and the illuminating parameters.

A system for constructing a high dynamic range image according to another exemplary embodiment of the present disclosure is disclosed. The system comprises a light generating device, a reflective mirror device, a controller, an image capturing device and an image processing module. The light generating device is utilized to generate a light beam. The reflective mirror device is utilized to direct the light beam to an object. The controller is utilized to generate an intensity controlling signal for controlling the reflective mirror device to modulate an accumulated duration for which the light beam illuminates the object in accordance with illuminating parameters, and to generate a direction controlling signal for controlling a reflection direction of the reflective mirror device. The image capturing device is utilized to obtain an original image of the object or a modulated image of the object. The image processing module is utilized to analyze the original image to generate the illuminating parameters, or to construct a high dynamic range image of the object in accordance with the modulated image and the illuminating parameters.

A method for constructing a high dynamic range image according to another embodiment of the present disclosure is disclosed. The method comprises the steps of: scanning an object with a light beam to obtain an original image of the object; analyzing the original image to obtain illuminating parameters for different areas of the object; modulating the intensity of the light beam according to the illuminating parameters to generate a modulated light beam; scanning the object with the modulated light beam to obtain a modulated image of the object; and constructing a high dynamic range image of the object in accordance with the modulated image and the illuminating parameters.

A method for constructing a high dynamic range image according to another embodiment of the present disclosure is disclosed. The method comprises the steps of: scanning an object with a light beam to obtain an original image of the object; analyzing the original image to obtain illuminating parameters for different areas of the object; controlling a reflective mirror device to modulate an accumulated illumination duration for which the light beam illuminates the object in accordance with the illuminating parameters, so as to obtain a modulated image of the object; and constructing a high dynamic range image of the object in accordance with the modulated image and the illuminating parameters.

The foregoing has outlined rather broadly the features and technical advantages of the present disclosure in order that the detailed description of the disclosure that follows may be better understood. Additional features and advantages of the disclosure will be described hereinafter, and form the subject of the claims of the disclosure. It should be appreciated by those skilled in the art that the conception and specific embodiment disclosed might be readily utilized as a basis for modifying or configuring other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE SEVERAL VIEWS OF THE DRAWINGS

The accompanying drawings, which are incorporated in and constitute a part of this specification, illustrate embodiments of the disclosure and, together with the description, serve to explain the principles of the disclosure.

FIG. 1 illustrates a schematic view of a system for constructing a high dynamic range image according to an exemplary embodiment of the present disclosure;

FIG. 2 illustrates a schematic view of a system for constructing a high dynamic range image according to another exemplary embodiment of the present disclosure;

FIG. 3 illustrates a schematic view of a system for constructing a high dynamic range image according to another exemplary embodiment of the present disclosure;

FIG. 4 illustrates a schematic view of a system for constructing a high dynamic range image according to another exemplary embodiment of the present disclosure;

FIG. 5 shows a schematic view of a method for constructing a high dynamic range image according to another exemplary embodiment of the present disclosure;

FIG. 6 illustrates a schematic view of a system for constructing a high dynamic range image according to another exemplary embodiment of the present disclosure; and

FIG. 7 shows a schematic view of a method for constructing a high dynamic range image according to another exemplary embodiment of the present disclosure.

### DETAILED DESCRIPTION OF THE INVENTION

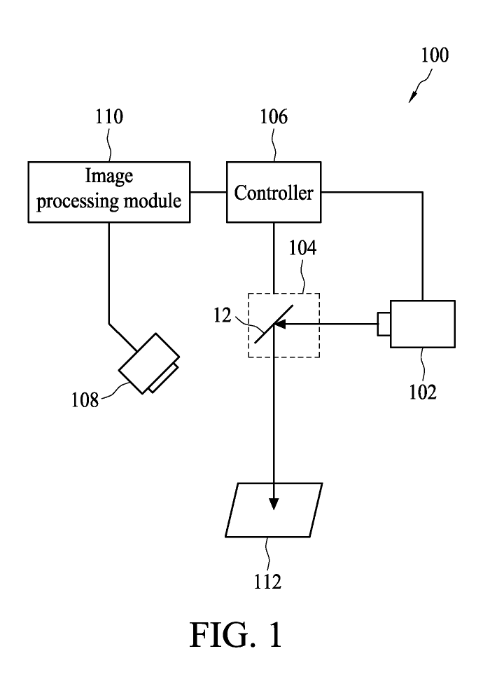

FIG. 1 illustrates a system 100 for constructing a high dynamic range image according to an exemplary embodiment of the present disclosure. The system 100 comprises a light generating device 102, a reflective mirror device 104, a controller 106, an image capturing device 108 and an image processing module 110. The light generating device is utilized to generate a light beam. In accordance with an exemplary embodiment, the light beam is a collimated light beam. The reflective mirror device 104 is utilized to direct the light beam to different areas of an object 112, so as to scan all areas of the object 112. The reflective mirror device 104 comprises a reflective mirror module 12 with two rotational degrees of freedom (DOFs) for directing the light beam to the object 112. The controller 106 is utilized to generate a direction controlling signal for controlling a reflection direction of the reflective mirror device 104. The controller 106 is also utilized to generate an intensity controlling signal for controlling the light generating device 102, so as to modulate an intensity of the light beam in accordance with illuminating parameters. The image capturing device 108 is utilized to obtain an image of the object 112. The image is an original image of the object 112 or a modulated image of the object 112. In accordance with an exemplary embodiment, the image capturing device 108 utilizes a charge-coupled device (CCD) sensor or a complementary metal-oxide-semiconductor (CMOS) sensor to obtain the image of the object 112. The image processing module 110 is utilized to analyze the original image of the object 112 to generate the illuminating parameters, or to construct a high dynamic range image of the object 112 in accordance with the modulated image and the illuminating parameters.

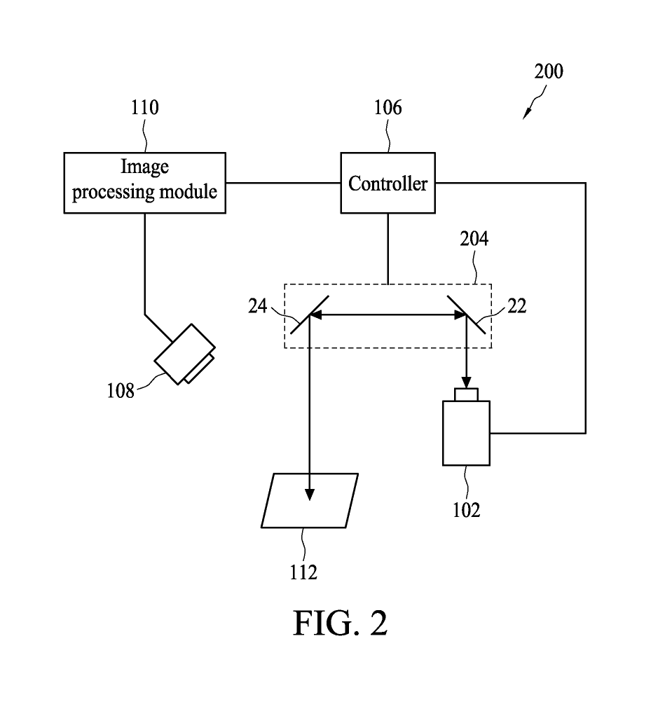

FIG. 2 illustrates a system 200 for constructing a high dynamic range image according to another exemplary embodiment of the present disclosure. The system 200 comprises a light generating device 102, a reflective mirror device 204, a controller 106, an image capturing device 108 and an image processing module 110. The reflective mirror device 204 utilizes a reflective mirror module 22 with one rotational degree of freedom (DOF) and a reflective mirror module 24 with one DOF. A rotation axis of the reflective mirror module 22 and a rotation axis of the second reflective mirror module 24 are perpendicular to one another.

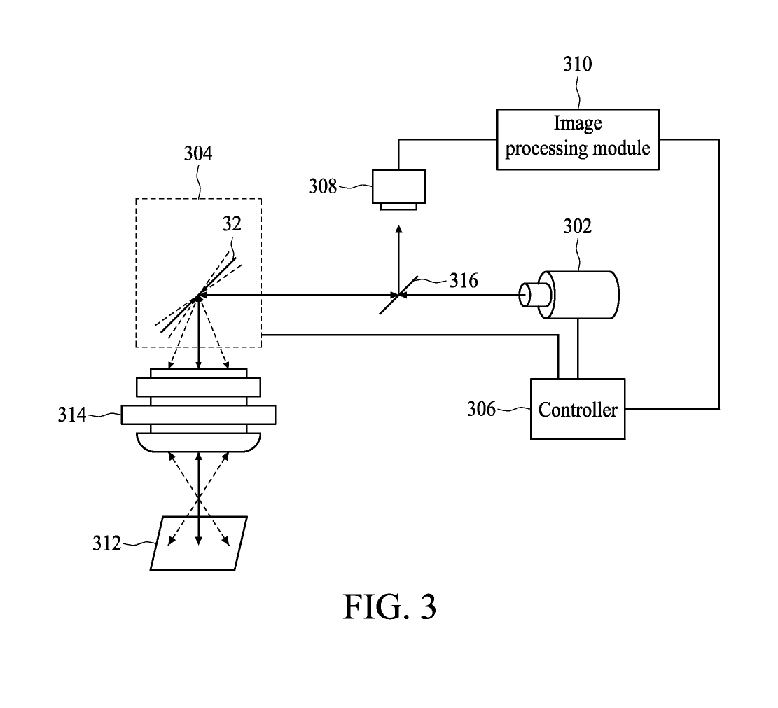

FIG. 3 illustrates a confocal system 300 for constructing a high dynamic range image according to another exemplary embodiment of the present disclosure. The confocal system 300 comprises a light generating device 302, a reflective mirror device 304, a controller 306, an image capturing device 308, an image processing module 310, an objective lens 314 and a beam splitter 316. The functions of the light generating device 302, the reflective mirror device 304, the controller 306, the image capturing device 308, and the image processing module 310 are the same as the functions of the above-mentioned light generating device 102, reflective mirror device 104, controller 106, image capturing device 108, and image processing module 110. In the confocal system 300, the reflective mirror device 304 utilizes a reflective mirror module 32 with two rotational DOFs for reflecting the light beam generated by the light generating device 302 to focus on different areas of the object 312 through the objective lens 314.

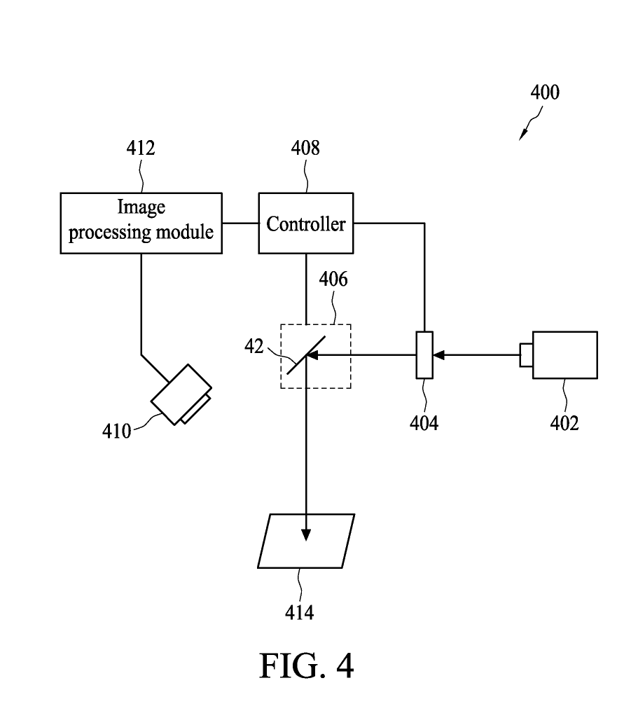

FIG. 4 illustrates a system 400 for constructing a high dynamic range image according to another exemplary embodiment of the present disclosure. The system 400 comprises a light generating device 402, an intensity modulator 404, a reflective mirror device 406, a controller 408, an image capturing device 410 and an image processing module 412. The light generating device 402 is utilized to generate a light beam. In accordance with an exemplary embodiment, the light beam is a collimated light beam. The intensity modulator 404 is utilized to modulate an intensity of the light beam in accordance with an intensity controlling signal. The intensity modulator 404 can be a reflective type intensity modulator or a transmission type intensity modulator. The reflective type intensity modulator comprises a digital mirror device (DMD) or a liquid crystal on silicon (LCoS) device. The transmission type intensity modulator comprises a liquid crystal device. The reflective mirror device 406 is utilized to direct the light beam to different areas of an object 414, so as to scan all areas of the object 414. The reflective mirror device 406 comprises a reflective mirror module 42 with two rotational DOFs for directing the light beam to the object 414. The reflective mirror device 406 can also utilize two reflective mirror modules, wherein each reflective mirror module has one rotational DOF, and rotation axes of the two reflective mirror modules are perpendicular to one another. The controller 408 is utilized to generate a direction controlling signal for controlling a reflection direction of the reflective mirror device 406. The controller 408 is also utilized to generate the intensity controlling signal in accordance with illuminating parameters for controlling the intensity modulator 404 to modulate the intensity of the light beam. The image capturing device 410 is utilized to obtain an image of the object 414. The image is an original image of the object 414 or a modulated image of the object 414. In accordance with an exemplary embodiment, the image capturing device 410 utilizes a CCD sensor or a CMOS sensor to obtain the image of the object 112. The image processing module 412 is utilized to analyze the original image of the object 414 to generate the illuminating parameters, or to construct a high dynamic range image of the object 414 in accordance with the modulated image and the illuminating parameters.

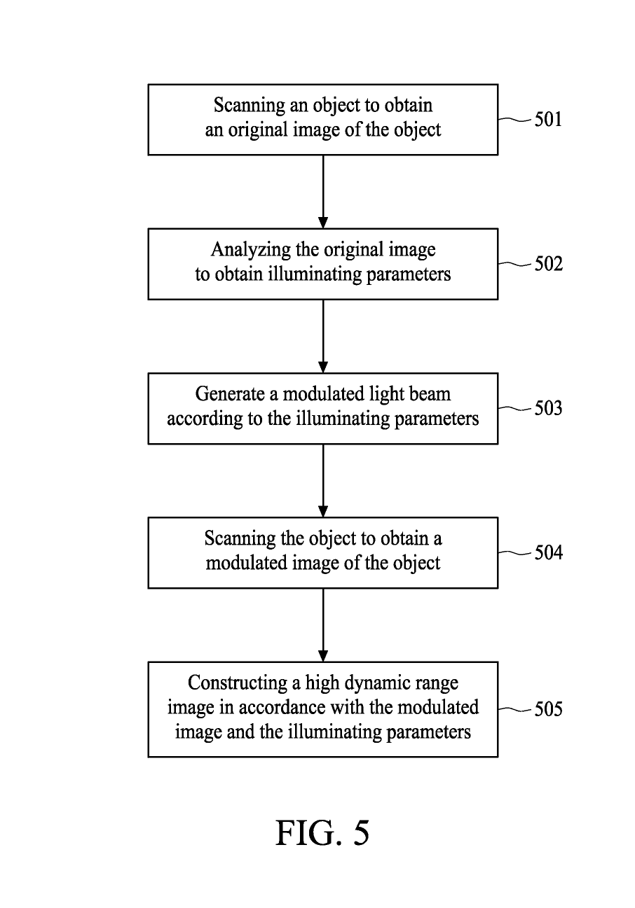

FIG. 5 shows a flowchart of a method for constructing a high dynamic range image according to another exemplary embodiment of the present disclosure. FIG. 1 and FIG. 5 are utilized together to describe the exemplary embodiment. In step 501, an object 112 is scanned by a light beam generated by a light generating device 102 through a reflective mirror device 104. Next, an original image of the object 112 is obtained by an image capturing device 108. In addition, a reflective mirror device 204 in FIG. 2 can be substituted for the reflective mirror device 104. If the surface material, the surface structure or the surface roughness of the object 112 is inconsistent, overexposure or underexposure will be caused at some areas of the object 112 during the process of capturing the image of the object 112. Therefore, the corresponding pixels of the captured image are overly bright or dull. In step 502, illuminating parameters of different areas of the object 112 are obtained by analyzing the original image with an image processing module 110. The illuminating parameters comprise an applied intensity value for each area of the object 112. In other words, the intensity of the light beam will be decreased for the overexposed areas or increased for the underexposed areas. In step 503, the light generating device 102 is controlled to modulate the intensity of the light beam according to the illuminating parameters, so as to generate a modulated light beam. In step 504, the object 112 is scanned again by the modulated light beam, and a modulated image of the object 112 is obtained by using the image capturing device 108. Finally in step 505, a high dynamic range image of the object 112 is constructed in accordance with the modulated image and the illuminating parameters. For example, if an image with a limited dynamic range of 0-255 is obtained by using the image capturing device 108, a gray-level value of a pixel of the modulated image is 200, and 50% light intensity of the normal light beam is utilized for the modulated light beam to illuminate the object 112 in accordance with the illuminating parameters, then the actual gray-level value of the pixel is 400. In contrast, if 200% light intensity of the normal light beam is utilized for the modulated light beam to illuminate the object 112 in accordance with the illuminating parameters, the actual gray-level value of the pixel is 100.

In addition, if the light generating device 102 generates a light beam with fixed intensity, a light modulator 404 in a system 400 in FIG. 4 can be used in step 503. The light modulator 404 is controlled to modulate the intensity of a light beam according to the illuminating parameters, so as to generate the modulated light beam.

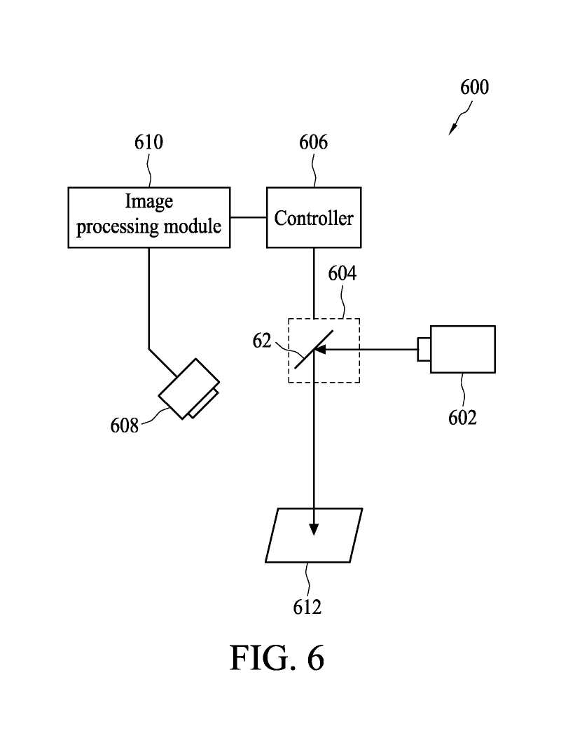

FIG. 6 illustrates a system 600 for constructing a high dynamic range image according to another exemplary embodiment of the present disclosure. The system 600 comprises a light generating device 602, a reflective mirror device 604, a controller 606, an image capturing device 608 and an image processing module 610. The light generating device 602 is utilized to generate a light beam. In accordance with an exemplary embodiment, the light beam is a collimated light beam. The reflective mirror device 604 is utilized to direct the light beam to different areas of an object 612, so as to scan all areas of the object 612. The reflective mirror device 604 comprises a reflective mirror module 62 with two DOFs for directing the light beam to the object 612. The reflective mirror device 604 can also utilize two reflective mirror modules, wherein each reflective mirror module has one rotational DOF, and rotation axes of the two reflective mirror modules are perpendicular to one another. The controller 606 is utilized to generate a direction controlling signal for controlling a reflection direction of the reflective mirror device 604. The controller 604 is also utilized to generate the intensity controlling signal in accordance with illuminating parameters for controlling the intensity modulator 604 to modulate an accumulated illumination duration for which the light beam illuminates the object 612. The image capturing device 608 is utilized to obtain an image of the object 612. The image is an original image of the object 612 or a modulated image of the object 612. In accordance with an exemplary embodiment, the image capturing device 608 utilizes a CCD sensor or a CMOS sensor to obtain the image of the object 612. The image processing module 610 is utilized to analyze the original image of the object 612 for generating the illuminating parameters, or to construct a high dynamic range image of the object 612 in accordance with the modulated image and the illuminating parameters.

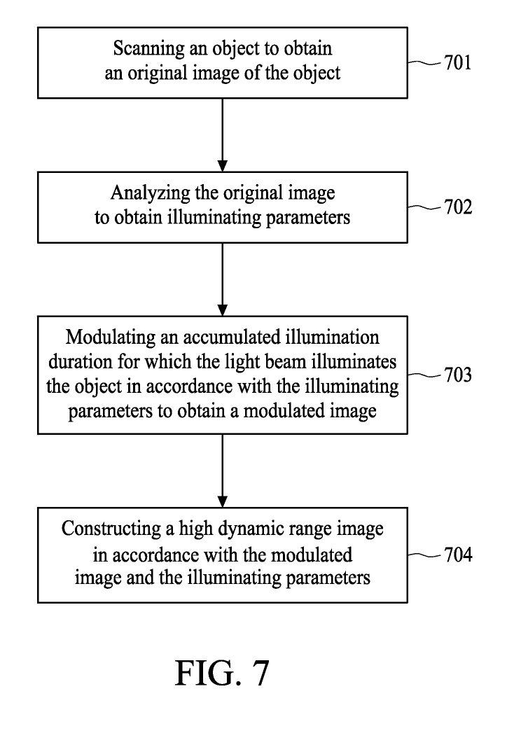

FIG. 7 shows a flowchart of a method for constructing a high dynamic range image according to another exemplary embodiment of the present disclosure. FIG. 6 and FIG. 7 are utilized together to describe the exemplary embodiment. In step 701, an object 612 is scanned by a light beam generated by a light generating device 602 through a reflective mirror device 604. Next, an original image of the object 612 is obtained by an image capturing device 608. In addition, a reflective mirror device 204 in FIG. 2 can be substituted for the reflective mirror device 604. If the surface material, the surface structure or the surface roughness of the object 612 is inconsistent, overexposure or underexposure will be caused at some areas of the object 612 during the process of capturing the image of the object 612. Therefore, the corresponding pixels of the captured image are overly bright or dull. In step 702, illuminating parameters of different areas of the object 612 are obtained by analyzing the original image with an image processing module 610. The illuminating parameters comprise an accumulated illumination time for each area of the object 112. In other words, the accumulated illumination time will be decreased for the overexposed areas or be increased for the underexposed areas. In step 703, the reflective mirror device 604 is controlled to modulate an accumulated illumination duration for which the light beam illuminates the object 612 in accordance with the illuminating parameters, so as to obtain a modulated image of the object 612. In step 704, a high dynamic range image of the object 612 is constructed in accordance with the modulated image and the illuminating parameters. For example, if an image with a limited dynamic range of 0-255 is obtained by using the image capturing device 608, a gray-level value of a pixel of the modulated image is 200, and 50% accumulated illumination time of the normal accumulated illumination time is utilized for illuminating the object 612 in accordance with the illuminating parameters, then the actual gray-level value of the pixel is 400. In contrast, if 200% accumulated illumination time of the normal accumulated illumination time is utilized for illuminating the object 612 in accordance with the illuminating parameters, the actual gray-level value of the pixel is 100.

The above-described exemplary embodiments are intended to be illustrative of the disclosure principle only. Those skilled in the art may devise numerous alternative embodiments without departing from the scope of the following claims.

We claim:

1. A system for constructing a high dynamic range image, comprising:
a light generating device utilized to generate a light beam;
a reflective mirror device utilized to direct the light beam to an object;
a controller utilized to generate an intensity controlling signal for controlling the light generating device to modulate an intensity of the light beam in accordance with illuminating parameters, and to generate a direction controlling signal for controlling a reflection direction of the reflective mirror device;
an image capturing device utilized to obtain an original image of the object or a modulated image of the object; and
an image processing module utilized to analyze the original image to generate the illuminating parameters, or to construct a high dynamic range image of the object in accordance with the modulated image and the illuminating parameters.

2. The system of claim 1, wherein the reflective mirror device comprises a first reflective mirror module with one rotational degree of freedom (DOF) and a second reflective mirror module with one DOF, for directing the light beam to the object.

3. The system of claim 2, wherein a rotation axis of the first reflective mirror module and a rotation axis of the second reflective mirror module are perpendicular to one another.

4. The system of claim 1, wherein the reflective mirror device comprises a third reflective mirror module with two rotational degrees of freedom (DOFs) for directing the light beam to the object.

5. The system of claim 1, wherein the image capturing device comprises a charge-coupled device (CCD) sensor or a complementary metal-oxide-semiconductor (CMOS) sensor.

6. A system for constructing a high dynamic range image, comprising:
a light generating device utilized to generate a light beam;
an intensity modulator utilized to modulate the intensity of the light beam in accordance with an intensity controlling signal;
a reflective mirror device utilized to direct the light beam to an object;
a controller utilized to generate the intensity controlling signal in accordance with illuminating parameters, and to generate a direction controlling signal for controlling a reflection direction of the reflective mirror device;
an image capturing device utilized to obtain an original image of the object or a modulated image of the object; and
an image processing module utilized to analyze the original image to generate the illuminating parameters, or to construct a high dynamic range image of the object in accordance with the modulated image and the illuminating parameters.

7. The system of claim 6, wherein the reflective mirror device comprises a first reflective mirror module with one rotational degree of freedom (DOF) and a second reflective mirror module with one DOF for directing the light beam to the object.

8. The system of claim 7, wherein a rotation axis of the first reflective mirror module and a rotation axis of the second reflective mirror module are perpendicular to one another.

9. The system of claim 6, wherein the reflective mirror device comprises a third reflective mirror module with two rotational degrees of freedom (DOFs) for directing the light beam to the object.

10. The system of claim 6, wherein the intensity modulator is a reflective type intensity modulator or a transmission type intensity modulator.

11. The system of claim 10, wherein the reflective type intensity modulator comprises a digital mirror device (DMD) or a liquid crystal on silicon (LCoS) device.

12. The system of claim 10, wherein the transmission type intensity modulator comprises a liquid crystal device.

13. The system of claim 6, wherein the image capturing device comprises a charge-coupled device (CCD) sensor or a complementary metal-oxide-semiconductor (CMOS) sensor.

14. A system for constructing a high dynamic range image, comprising:
a light generating device utilized to generate a light beam;
a reflective mirror device utilized to direct the light beam to an object;
a controller utilized to generate an intensity controlling signal for controlling the reflective mirror device to modulate an accumulated illumination duration for which the light beam illuminates the object in accordance with illuminating parameters, and to generate a direction controlling signal for controlling a reflection direction of the reflective mirror device;
an image capturing device utilized to obtain an original image of the object or a modulated image of the object; and
an image processing module utilized to analyze the original image to generate the illuminating parameters, or to construct a high dynamic range image of the object in accordance with the modulated image and the illuminating parameters.

15. The system of claim 14, wherein the reflective mirror device comprises a first reflective mirror module with one rotational degree of freedom (DOF) and a second reflective mirror module with one DOF for directing the light beam to the object.

16. The system of claim 15, wherein a rotation axis of the first reflective mirror module and a rotation axis of the second reflective mirror module are perpendicular to one another.

17. The system of claim 14, wherein the reflective mirror device comprises a third reflective mirror module with two rotational degrees of freedom (DOFs) for directing the light beam to the object.

18. The system of claim 14, wherein the image capturing device comprises a charge-coupled device (CCD) sensor or a complementary metal-oxide-semiconductor (CMOS) sensor.

19. A method for constructing high dynamic range images, comprising the steps of:
scanning an object with a light beam to obtain an original image of the object;
analyzing the original image to obtain illuminating parameters for different areas of the object;
modulating the intensity of the light beam according to the illuminating parameters to generate a modulated light beam;
scanning the object with the modulated light beam to obtain a modulated image of the object; and
constructing a high dynamic range image of the object in accordance with the modulated image and the illuminating parameters.

20. The method of claim 19, wherein the light beam is generated by a light generating device.

21. The method of claim 20, wherein the light generating device is controlled to modulate the intensity of the light beam for generating the modulated light beam.

22. The method of claim 19, wherein an intensity modulator is utilized to modulate the intensity of the light beam for generating the modulated light beam.

23. The method of claim 22, wherein the intensity modulator is a reflective type intensity modulator or a transmission type intensity modulator.

24. The method of claim 23, wherein the reflective type intensity modulator comprises a digital mirror device (DMD) or a liquid crystal on silicon (LCoS) device.

25. The method of claim 23, wherein the transmission type intensity modulator comprises a liquid crystal device.

26. The method of claim 19, wherein an image capturing device is utilized to obtain the original image of the object or the modulated image of the object.

27. The method of claim 26, wherein the image capturing device comprises a charge-coupled device (CCD) sensor or a complementary metal-oxide-semiconductor (CMOS) sensor.

28. The method of claim 19, wherein a reflective mirror device is utilized to scan the object.

29. The method of claim 28, wherein the reflective mirror device comprises a first reflective mirror module with one rotational degree of freedom (DOF) and a second reflective mirror module with one DOF for directing the light beam to the object, while a rotation axis of the first reflective mirror module and a rotation axis of the second reflective mirror module are perpendicular to one another.

30. The method of claim 28, wherein the reflective mirror device comprises a third reflective mirror module with two rotational degrees of freedom (DOFs) for directing the light beam to the object.

31. A method for constructing high dynamic range images, comprising the steps of:
scanning an object with a light beam to obtain an original image of the object;
analyzing the original image to obtain illuminating parameters for different areas of the object;
controlling a reflective mirror device to modulate an accumulated illumination duration for which the light beam illuminates the object in accordance with the illuminating parameters, so as to obtain a modulated image of the object; and
constructing a high dynamic range image of the object in accordance with the modulated image and the illuminating parameters.

32. The method of claim 31, wherein the light beam is generated by a light generating device.

33. The method of claim 31, wherein an image capturing device is utilized to obtain the original image of the object or the modulated image of the object.

34. The method of claim 33, wherein the image capturing device comprises a charge-coupled device (CCD) sensor or a complementary metal-oxide-semiconductor (CMOS) sensor.

35. The method of claim 31, wherein a reflective mirror device is utilized to scan the object.

36. The method of claim 35, wherein the reflective mirror device comprises a first reflective mirror module with one rotational degree of freedom (DOF) and a second reflective mirror module with one DOF for directing the light beam to the object, while a rotation axis of the first reflective mirror module and a rotation axis of the second reflective mirror module are perpendicular to one another.

37. The method of claim 35, wherein the reflective mirror device comprises a third reflective mirror module with two rotational degrees of freedom (DOFs) for directing the light beam to the object.
